(19) United States
(12) Patent Application Publication
(10) Pub. No.: US 2007/0234308 A1
(43) Pub. Date: Oct. 4, 2007

(54) Non-invasive automated accessibility validation

(76) Inventors: Barry Alan Feigenbaum, Austin, TX (US); Michael A. Squillace, Austin, TX (US)

Correspondence Address: IBM CORP. (MRN);c/o LAW OFFICE OF MICHAEL R. NICHOLS, 3001 S. HARDIN BLVD., STE. 110, PMB 155, MCKINNEY, TX, 75070-7702, US

(21) Appl. No.: 11/369,552

(22) Filed: Mar. 7, 2006

(51) Int. Cl. G06F 9/44

(52) U.S. Cl. 717/130

(57) ABSTRACT

A method, computer program product, and data processing system for automatically validating a GUI for accessibility are disclosed. In a preferred embodiment, a markup language, such as XML, is utilized to specify a set of declarative validation rules to be applied to components in an object-oriented GUI. GUI validation code is generated from the XML rules. This GUI validation code is incorporated into the software to be validated using aspect-oriented programming to insert the validation code at the point(s) in the software where the GUI is generated and/or rendered. When the software is executed and the GUI generated, the validation code is executed to verify that each component in the GUI hierarchy complies with the specified accessibility rules. The results of the validation are then reported to the developer.

### BACKGROUND OF THE INVENTION

1. Technical Field

The present invention relates generally to tools to aid in the design of graphical user interfaces (GUIs) and, more specifically, to validate such interfaces for accessibility for use by disabled users and others.

2. Description of the Related Art

The earliest interactive computers relied on tele-typewriter (TTY) or text terminals for interactive communication with a human operator. These early forms of human-computer interaction (HCI) allowed for only text- or character-based information exchange. Many computer software products today utilize a graphical user interface or GUI (typically pronounced like “gooey”). A GUI is visual means of human-computer interaction that utilizes pictures or other visual representations besides text or characters.

Most GUIs make use of visual controls that are displayed on the user's display and actuated by user input. Typical visual controls include, but are not limited to, buttons, text fields (for entering text), radio buttons, checkboxes, selection boxes, and menu bars. In a typical GUI, a pointing device, such as a mouse, is used to move a cursor around a display and actuate visual controls. GUIs usually also make use of static display components, such as labels and icons, which are intended to be displayed, but generally have no input function, per se. Sometimes these static display components may serve an input role, however, when they are moved around on the display relative to other features on the display (e.g., dragging an icon of a file to a trash can icon to delete a file, for example).

Many GUIs are what is known as a “windowing” interface, because they arrange information visually on a display in the form of panels or “windows” superimposed on a background called a “desktop.” In many systems, windows may be dragged to different locations on the display with a pointing device, enlarged, reduced, made to overlap with other windows. Typically, a window will contain a number of visual controls to allow a user to interact with a computer program by actuating the controls in the window. A special form of window, known as a “dialog box,” is displayed by a program when some input is required from a user.

Windows, visual controls, and static display components are what are known as GUI components, because they are the building blocks that make up the GUI. Some GUI components, such as windows, are known as “container components” (or simply “containers”), because they may contain other components. For example, a window may contain visual controls, such as a button or menu bar, and static display components, such as text labels or icons. A container may also contain another container. For example, in some windowing-based word processors, the word processor itself occupies a (main) window, while each file under editing occupies another window within the main window.

Container components include windows, but may also include other components, which may be visible or invisible. For example, the JAVA™ programming language produced by Sun Microsystems, Inc. of Mountain View, Calif., defines various visible container components, such as windows and dialog boxes, as well as invisible container components, such as the “java.awt.Panel” container component, which is used solely to group a number of contained components into a single unit. Some examples of containers include, but are not limited to, windows, dialog boxes, panels, tabbed panels, notebook pages, and any other GUI components that have a capability of containing one or more other GUI components.

The actual functionality for providing basic operations on GUI components, such as displaying the components or detecting user input directed at the components (e.g., from pointing at or clicking on a component with a pointing device), is often provided by system-level software, such as an operating system. Generally speaking, applications will issue calls to system-level software for creating and maintaining GUIs, while the system-level software detects user input events that are directed at particular GUI components and sends event notifications to the applications that are responsible for those GUI components.

For example, the WINDOWS® operating system produced by Microsoft, Inc. of Redmond, Wash. provides services for the creation of GUIs and relaying of user input events to appropriate applications. The main interface for the WINDOWS® operating system itself is a GUI as well. In other settings, higher-level system software may operate on top of an operating system kernel (e.g., as a daemon or background process) to provide GUI services. For example, “X11” is an open-source GUI engine that operates as a process in an operating system. X11 adopts a client-server model in that an X11 server process accepts requests from applications (clients) for providing GUI services and relays user input events that pertain to particular GUI components to the applications associated with those components.

Alternatively, an application may contain its own code for providing GUI services. Typically, this code will come in the form of a reusable code library for performing basic GUI operations.

Many modern programming language implementations have built-in features for producing GUIs, usually either by providing an interface to GUI services provided by system-level software or by including libraries of low-level GUI code for which an interface in the programming language is provided. The JAVA™ programming language, for example, is an object-oriented programming language that includes standard application programming interfaces (APIs) for defining GUIs. Two APIs that are currently part of the JAVA™ programming language standard are the Abstract Windowing Toolkit (AWT) API and the Swing API. In the JAVA™ programming language, as is typical of object-oriented GUI APIs, each type of GUI component is defined as a class.

In an object-oriented programming language, a class is a definition of a data type that includes a collection of data, called member variables, and a set of operations that may be performed on the data, called methods (or alternatively, member functions). An actual collection of data in the data type defined by a class is called an object. In object-oriented programming (OOP) parlance, an object is said to be an “instance” of the class, because it is a data structure that is defined in accordance with the class. The run-time process of generating an object in an object-oriented programming language is called “instantiation,” and an object that exists at run-time is said to be “instantiated.”

Object-oriented programming languages also typically provide for what is known as “inheritance.” Using an inheritance a new class (called a “descendant” class) can be defined in terms of one or more existing classes (called “base” classes) so that the descendant class inherits one or more of the member variables or methods of the base class. For example, in the JAVA™ programming language's AWT API, “Container” is a descendant class of a base class called “Component,” the “Container” class will include at least some of the methods and member variables of “Component.” We thus say that “Container” is descended from “Component.” In many cases, a descendant class will include additional methods or member variables that are not inherited from the base class.

Also, a descendent class may be written so as to override the base class's code for a particular method. For example, the base class “Container” may have a method called “show,” for displaying a GUI component, which the descendant class “Container” inherits. Since displaying a container (which may contain other components) is more specific than displaying a generic GUI component, the “Container” class may define different code for “show” than that of the “Component” class.

This is important, since in most object-oriented languages, an object in a descendant class is treated as being a more specific instance of the base class. Thus, a “Container” object may be stored in a variable of type “Component,” or a method that takes a “Component” as an argument can also take a “Container” as an argument, since a “Container” will inherit characteristics (i.e., member variables and methods) from “Component.” This ability to treat objects from descendant classes as if they were instances of base classes is called “polymorphism.”

In an object-oriented GUI API, such as those provided by the JAVA™ programming language, GUI components are instantiated as objects, and relationships are established between the instantiated objects in order to define the placement and behavior of GUI components with respect to each other. For example, a “containment relation” is a relationship between GUI components that relates a container component to the components contained by that container component. In the JAVA™ programming language, for example, a component typically enters into a containment relation with a container through a method of the container called “add.”

A typical GUI component has one or more attributes that define particular properties of the component. For example, a “button” component in a typical windowing GUI will have attributes that define the size of the button on the display, the text or graphics displayed on the face of the button, the background color of the button, a keyboard shortcut associated with the button, and the like. In general, the portion of program code (e.g., function, method, subroutine, procedure, etc.) that instantiates a GUI component will also contain a number of lines of code that set the attributes for that component to desired values. In the JAVA™ programming language and other object-oriented programming systems, for example, components generally have methods that can be executed to set particular attributes of the component.

GUIs, and in particular object-oriented GUIs, generally employ what are known as “event handlers” to process GUI events as they occur. Some examples of GUI events are a user keystroke, and the moving, clicking, or dragging of a mouse. An event handler is a portion of code (e.g., a function or an object) that contains instructions for responding to one or more events that may occur with respect to a component or set of components in a GUI. Most GUI-based programs are designed to execute in a generally idle state until directed by the user to perform some action via one or more GUI events. This style of programming is known as “event-driven programming.”

Programming GUIs, even in an object-oriented programming language such as JAVA™, is generally considered to be a very labor-intensive process. This is largely due to the fact that most commonly-used computer languages have an imperative semantics (i.e., they express programs in terms of sequences of instructions). While imperative languages are a natural fit for non-interactive “batch” processes, imperative languages tend to be relatively awkward to use for expressing the concepts that underlie most GUIs, namely a structured arrangement of GUI components and event-driven execution. Sequences of imperative instructions must be written to construct the GUI piece-by-piece. Consequently, GUI code tends to be rather complex and tedious to write.

A number of efforts in the GUI field have been directed to simplifying the process of constructing GUIs, and in particular, GUIs constructed in an object-oriented programming language. One way of achieving this goal is to provide tools or application programming interfaces (APIs) that allow GUIs to be specified using a “declarative” or “descriptive” representation. In a declarative language, the relationships between the various constructs in the language are explicitly declared or described in terms of the relationships themselves. One particularly convenient manner of specifying the hierarchical structure of an object-oriented GUI in a declarative manner is to utilize Extensible Markup Language (XML). This approach is described, in general, in commonly-assigned, co-pending U.S. patent application Ser. No. 10/392,806, published as US 20040183838 (LAHIRI) 2004-09-23.

Extensible Markup Language, more commonly referred to as “XML,” is a character-based markup language that is designed for annotating data with semantic information that can be parsed by a computer. XML is used to provide a standardized syntax for information exchange between software processes.

XML by itself has a very minimal semantics, as XML merely provides a standardized syntax for imposing a hierarchical structure on data. XML, like HTML (Hypertext Markup Language) and other similar markup languages, uses tags to encode structural information about the data. HTML, for example, uses tags to encode structural (e.g., headings, section breaks, etc.) and formatting information about a hypertext document. XML, on the other hand, is more general than HTML. While HTML defines tags that have a particular semantics related to document structuring, XML does not define particular tags, but provides only a syntax for creating user-defined tags. It is up to a user (e.g., a programmer, database administrator, etc.) to define semantic tags in XML. What minimal semantics is provided by XML itself is essentially limited to the ability of XML tags to form information hierarchies through the nesting of tags and the ability to associate data attributes with individual tags.

Essentially, what this means is that XML can be used to create markup languages that can be parsed using off-the-shelf parsing code. This allows developers to create custom languages for data exchange without the hassle of having to write a parser for the language. For instance, one can create a custom markup language for encoding musical scores by using XML tags. It would not be necessary to write a parser for the language, since a generic XML parser would immediately be able to parse the language. In short, XML provides a standardized, platform-independent format for data exchange, which decouples the language syntax from the language semantics such that a standardized syntax can be used to encode structured data having an arbitrary choice of semantics.

Thus, XML enables one to create development tools that can convert a declarative representation of a GUI into sequential, imperative instructions for the computer to execute to construct the specified GUI. Once a GUI has been created, however, it is important to verify the accessibility of the interface to ensure that it is usable by the widest audience of users possible. Keyboard equivalents, verbal descriptions, and other accessibility features allow software to be utilized by users for whom a visual point-and-click interface is impractical or impossible to use, including blind, visually impaired, and physically disabled users. Such features are also helpful when a mouse or other pointing device is unavailable or inoperative, when an icon or other GUI representation is unintuitive to the user, or when a user wishes to perform a frequently-used operation quickly without having to reach away from the keyboard to grasp the mouse.

International Business Machines Corporation and others have developed guidelines for making GUIs accessible. Verifying that a given GUI complies with these guidelines, however, is a non-trivial task. Accessibility validation generally involves either an exhaustive examination of source code or exhaustive user testing to ensure that a given program complies with the accessibility guidelines. This is not only tedious, but also prone to human error.

What is needed, therefore, is an automated method for validating a GUI for accessibility. The present invention provides a solution to this and other problems, and offers other advantages over previous solutions.

### SUMMARY OF THE INVENTION

Accordingly, the present invention provides a method, computer program product, and data processing system for automatically validating a GUI for accessibility. In a preferred embodiment, a markup language, such as XML, is utilized to specify a set of validation rules to be applied to components in an object-oriented GUI. GUI validation code is generated (as Java bytecode) from the XML rules. This GUI validation code is woven into the software to be validated using aspect-oriented programming to insert the validation code at the point(s) in the software where the GUI is generated and/or rendered. When the software is executed and the GUI generated, the validation code is executed to verify that each component in the GUI hierarchy complies with the specified accessibility rules. The results of the validation are then reported to the developer.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a diagram illustrating a traditional compile and link paradigm used in software development;

FIG. 2 is a diagram illustrating a compilation process utilizing aspect-oriented programming techniques, as might be applied to an embodiment of the present invention;

FIG. 3 is a diagram illustrating basic concepts of aspect-oriented programming as might be applied to an embodiment of the present invention;

FIG. 4 is a diagram illustrating a process of instrumenting object code or bytecode, as might be applied to an embodiment of the present invention;

FIG. 5 is a diagram illustrating a process of instrumenting object code or bytecode dynamically at run-time as might be applied to an embodiment of the present invention;

FIG. 6 is a diagram providing an overview of a process of generating and validating a GUI in accordance with a preferred embodiment of the present invention;

FIGS. 7-8 are diagrams illustrating portions of a markup language file in which validation rules for GUI components are specified declaratively in accordance with a preferred embodiment of the present invention;

FIG. 9 is a diagram illustrating a “dashboard” interface for reporting the results of GUI validation to a user in accordance with a preferred embodiment of the present invention;

FIG. 10 is a flowchart representation of a process of generating validation code and incorporating that validation code into a program to be validated in accordance with a preferred embodiment of the present invention;

FIG. 11 is a flowchart representation of a process of validating a graphical user interface using aspect-oriented validation code in accordance with a preferred embodiment of the present invention; and

FIG. 12 is a block diagram of a data processing system in which a preferred embodiment of the present invention may be implemented.

### DETAILED DESCRIPTION

The following is intended to provide a detailed description of an example of the invention and should not be taken to be limiting of the invention itself. Rather, any number of variations may fall within the scope of the invention, which is defined in the claims following the description.

Before delving into the specifics of a preferred embodiment of the present invention, it is helpful to understand what is meant by aspect-oriented programming. A brief introduction to the basic concepts of aspect-oriented programming is provided here by way of illustration. Aspect-oriented programming is both a programming language paradigm as well as a scheme for the compilation and execution of programs.

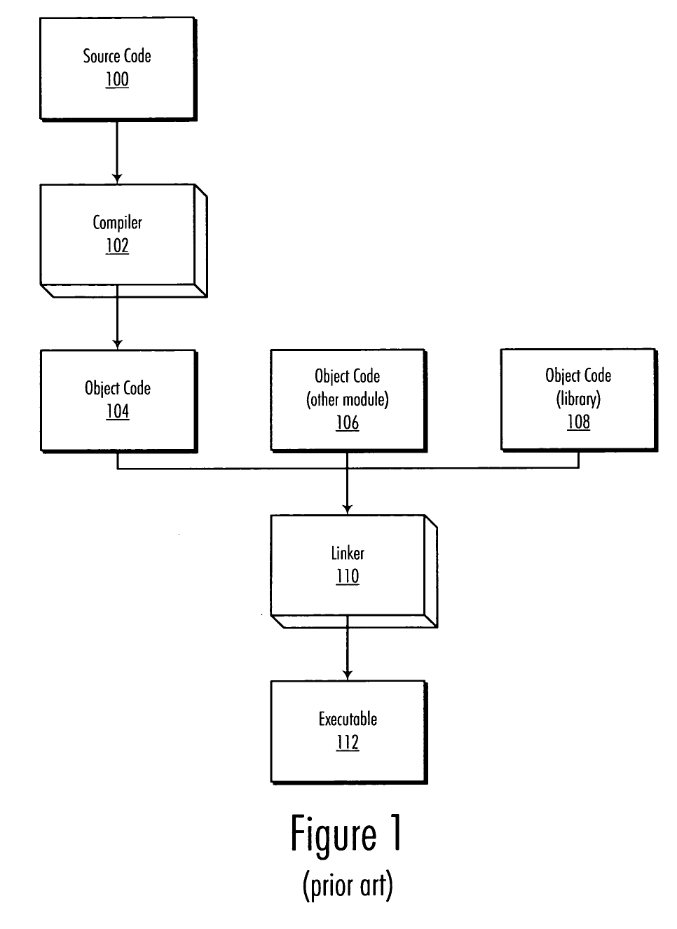

As shown in FIG. 1, under the traditional compilation paradigm for a computer program, source code 100 for the program is presented as input to a compiler 102, which translates source code 100 into object code 104. Object code 104 is made up of code in the native language of the computing platform (such as the hardware platform's native machine language or, in the case of a virtual machine such as a Java virtual machine, the executable bytecode the virtual machine is designed to execute). Object code 104 may be combined with other object code, such as other program modules 106 or library routines 108 by a linker 110. Linker 110 is used to combine the various individual modules of object code into an executable form 112.

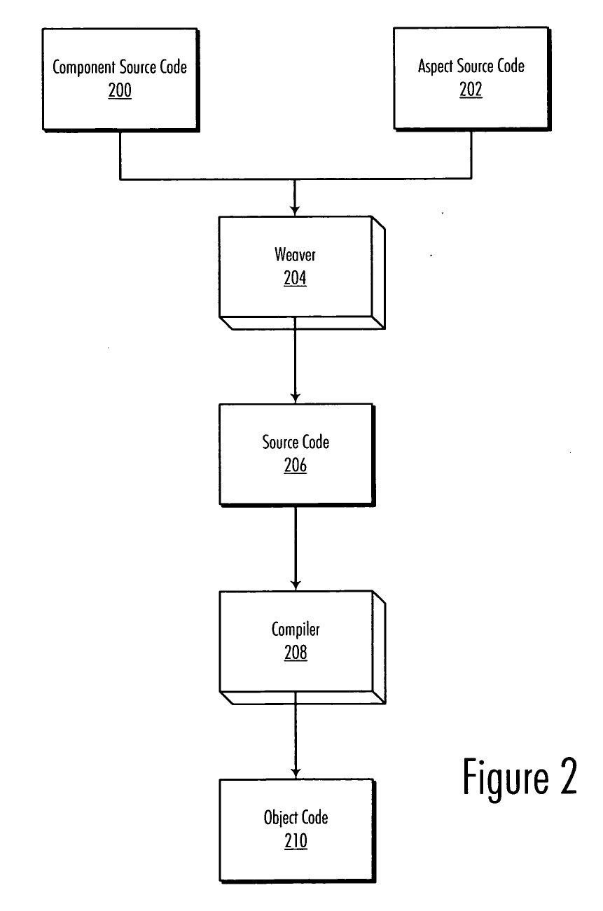

Aspect-oriented programming, on the other hand, adds an additional level of abstraction to the software development process. As shown in FIG. 2, a program is built from both component source code 200 and aspect source code 202. Component source code 200 is ordinary program code, much like source code 100 in FIG. 1. Aspect source code 202, on the other hand, is source code that operates on component source code 200 to modify and/or manipulate component source code 200 before inclusion into the final program. A development tool known as a weaver 204 performs the operations specified by aspect source code 202 on component source code 200 to obtain a resulting source code 206, which may be fed into a compiler 208 to obtain object code 210. Object code 210 may then be utilized in the same manner as object code 104 in FIG. 1.

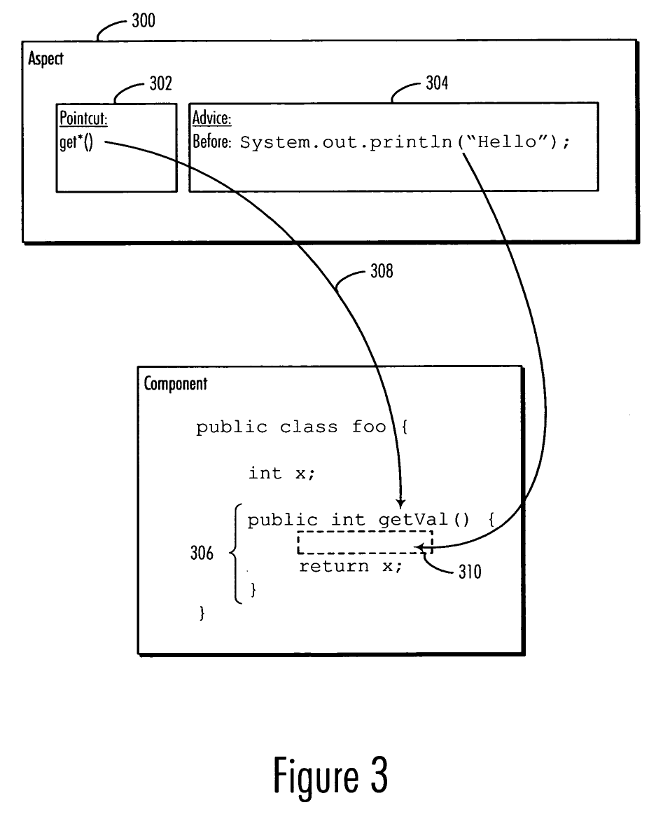

The basic mechanism for modifying component source code 200 using aspect source code 202 is described in FIG. 3. Aspects source code, such as aspect source code 202 in FIG. 2, is comprised of aspects, such as aspect 300 in FIG. 3. Aspect 300 comprises a pointcut 302 and advice code 304. Point cut 302 comprises a pattern that is used to identify particular features in the component source code (e.g., component source code 200 in FIG. 2). Advice code 304 contains program code that is used to modify features of the component source code identified by the pattern contained in pointcut 302. Some examples of advice to include “before advice” and “after advice.” “Before advice” is code that is intended to execute before the code feature identified by the pattern in the pointcut. Similarly, “after advice” is program code that is intended to be executed after the code feature identified by the pattern in the pointcut.

As shown in the example provided in FIG. 3, pointcut 302 specifies a pattern that identifies all methods beginning with the word “get.” (One skilled in the art will recognize that JAVA programs often utilize a naming convention wherein methods that set attributes of objects are prefixed with the word “set” and methods that access the values of attributes of objects are prefixed with the word “get.” Objects that follow this naming convention are referred to as “JavaBeans.”) Pointcut 302 will therefore identify any method having a name that begins with “get.” One such method is method 306, shown in FIG. 3. The fact that pointcut 302 identifies method 306 is represented in FIG. 3 by arrow 308. Advice code 304 contains before advice consisting of code to print the word “Hello” on the display console. Thus, the full semantics of aspect 300 is to identify each method having a name that begins with “get” and add code to the beginning of each such identified method to print the word “Hello” on the display console. Hence, when an aspect weaver is applied to aspect 300 and method 306, the result is to insert before advice code 304 in location 310 at the beginning of method 306.

Thus, as can be seen from FIG. 3, aspect-oriented programming provides a convenient mechanism for making global changes to program by matching patterns in the program code. Aspect-oriented programming might be thought of (in a very crude sense) as a sophisticated form of search and replace (as in a text editor or work processor). However, aspect-oriented programming is much more powerful than a textual search and replace, because aspect-oriented programming is capable of making global modifications to a program based on semantic features of the program, rather than by raw text searching. One skilled in the art will recognize that the ability AOP provides to make global changes to a complete set of program features allows modifications that might otherwise have to be manually replicated across the entire program to be made in a single operation, without risk that some of the set of features might be overlooked (as might be the case if the program were edited manually).

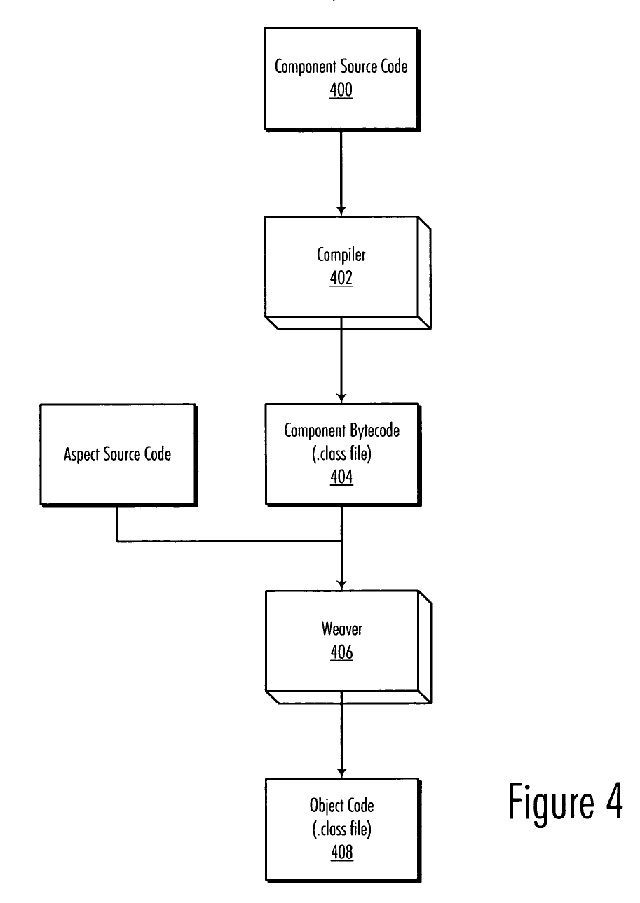

When dealing with component source code written in a language such as JAVA, which compiles predictably to a well-defined bytecode representation, even more sophisticated applications of aspect-oriented programming are possible. As shown in FIG. 4, one need not possess the actual component source code of the software to be modified using aspect-oriented programming. Aspects may be applied to well-defined byte code or object code (such as JAVA “.class” files). In the example depicted in FIG. 4, the original component source code (component source code 400) is already compiled (via compiler 402) into JAVA bytecode in the form of a “.class” file 404. Aspect source code 405 is then applied to bytecode 404 by weaver 406 to obtain resulting object code 308.

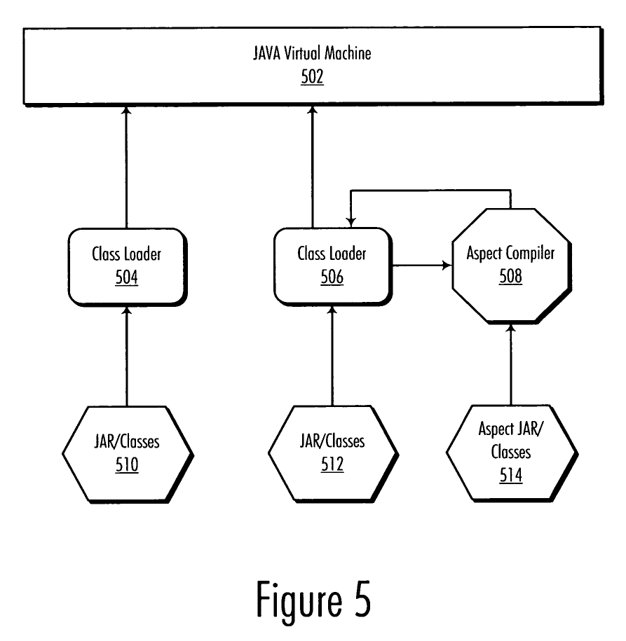

The weaving process may also be performed dynamically at runtime, as depicted in FIG. 5. In this example, a JAVA virtual machine 502 is used to execute the application. JAVA virtual machine 502 employs class loaders 504 and 506 to dynamically load and link object code in the form of JAR files and class files (e.g., JAR/classes 510 and 512). In the event that it is desired to apply aspect-oriented programming techniques in the runtime environment depicted in FIG. 5, a class loader, such as class loader 506, may be programmed to invoke an aspect compiler or weaver 508 to combine component code in the form of JAR/class files 512 with aspect JAR/class files 514 prior to dynamic linking and execution.

A preferred embodiment of the present invention validates a graphical user interface for accessibility by instrumenting program code with validation code designed to traverse the GUI hierarchy and validate each component in that hierarchy against a set of specified validation rules. Specifically, this preferred embodiment uses the JBoss-AOP engine for aspect-oriented programming, although other aspect-oriented tools, such as AspectJ, may also be used in an actual embodiment. JBoss-AOP is an open-source development environment to instrument program code intended to be executed in a JAVA runtime environment. AspectJ is a similar tool developed by researchers at Xerox Palo Alto Research Center (PARC) and is freely available. AspectJ provides an aspect specification language and weaver for use with the JAVA programming language (as component language).

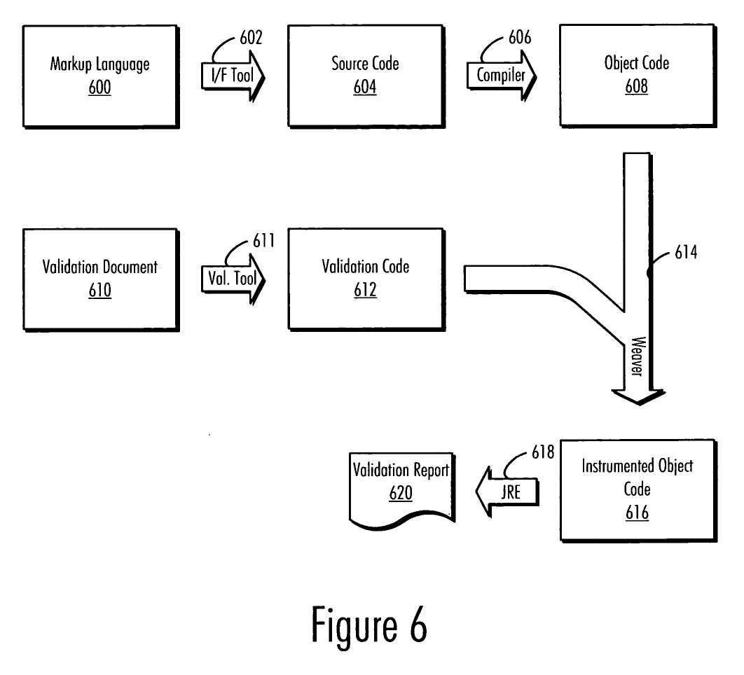

FIG. 6 is a diagram providing an overview of a process of generating and validating a GUI in accordance with a preferred embodiment of the present invention. Source code 604 for generating a graphical user interface is processed by a compiler 606 to generate object code 608, which is instrumented in accordance with a preferred embodiment of the present invention (q.v.). In a preferred embodiment, source code 604 is in an object-oriented programming language having an object-oriented application programming interface (API) for writing GUIs. Examples of such languages include, but are not limited to, JAVA™ and Python (and, in particular, the Jython variant of Python, which is intended to execute in a JAVA™ runtime environment). One skilled in the art will recognize, however, that the methods of the present invention are, in general, programming-language independent and that source code 604 may be generated in any of a number of computer languages, without limitation and without departing from the scope and spirit of the present invention.

As shown in FIG. 6, the GUI may be specified by the developer/programmer in the form of a document 600 written in a markup language, such as XML, which is then used by an interface tool 602 to generate source code 604 for the GUI. Such an interface tool is described in commonly assigned, co-pending U.S. patent application Ser. No. 11/289,052 (Attorney Docket No. AUS920050699US1), filed Nov. 29, 2005, which is incorporated herein by reference.

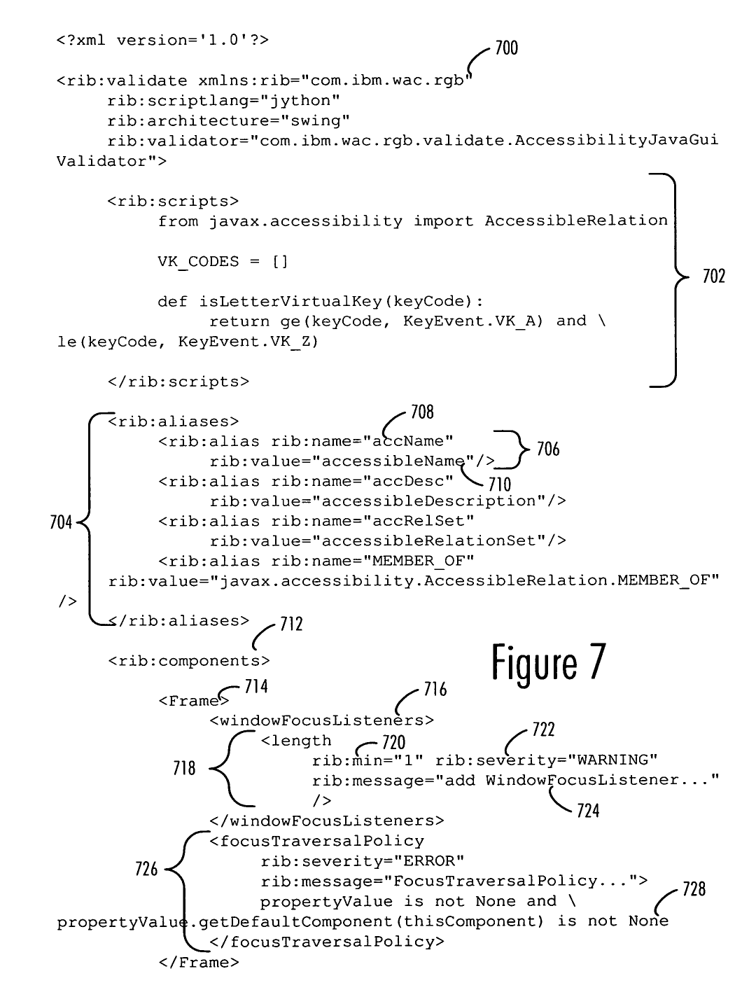

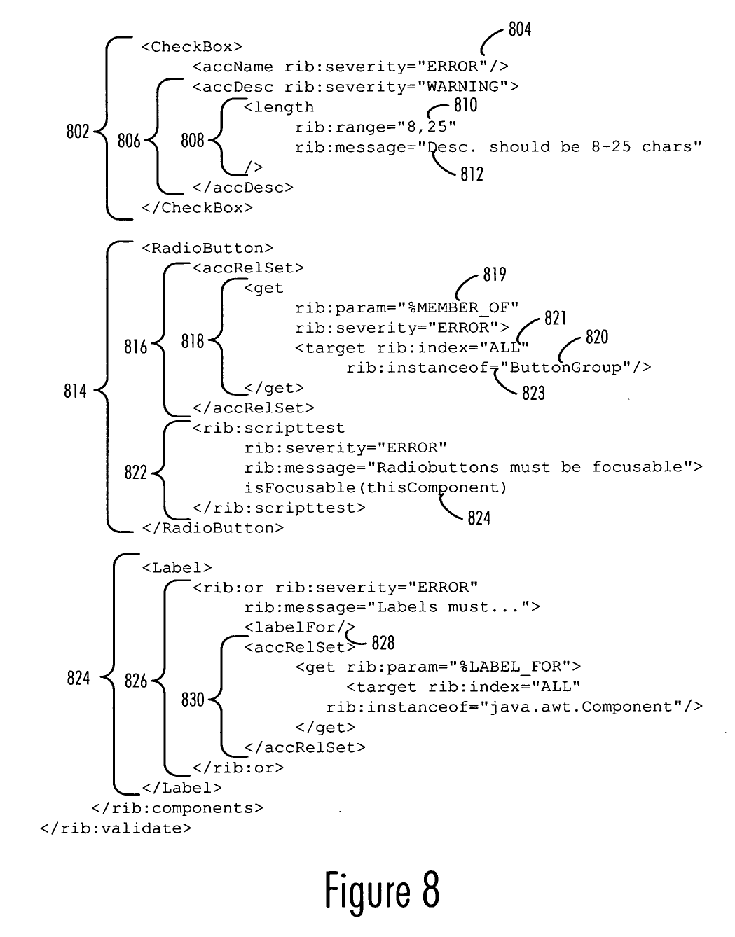

Validation document 610 is a declarative representation of a set of validation rules for GUIs. In a preferred embodiment, validation document 610 is implemented in the form of an XML document, as illustrated in FIGS. 7-8. A validation tool 611 is used to convert validation document 610 into executable JAVA code (validation code 612). Validation code 612 is executable JAVA code written in the form of the advice of an aspect, where the advice code is a routine for validating the components of a GUI against the rules set forth in validation document 610. Validation tool 611 has a pointcut that specifies that this advice code should be run once the GUI has been generated or rendered.

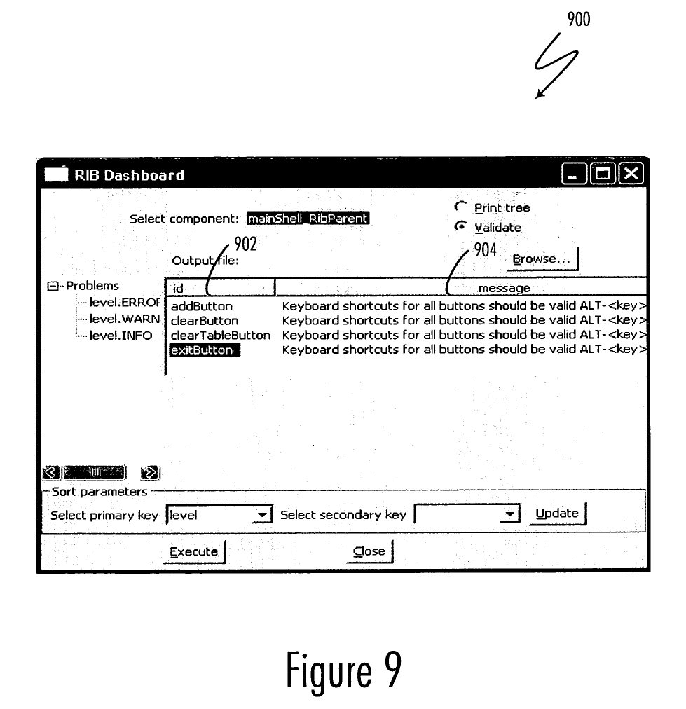

Weaver tool 614 incorporates validation code 612 into object code 608 to obtain instrumented object code 616. In this preferred embodiment, validation code 612 is specified using the JBoss-AOP aspect-oriented language and object code 608 is made up of JAVA bytecode. Hence, when object code 608 and validation code 612 are woven together, the resulting instrumented object code 616 may be executed in a JAVA runtime environment 618. When object code 616 is executed in JAVA runtime environment 618, the GUI is generated and the incorporated validation code is executed to verify that the generated GUI conforms to the validation rules set forth in validation document 610. A validation report 620 is then generated from the results of the validation process. Validation report 620 may take the form of a text output (for instance, a log file, an XML-based representation, or immediate output to stdout or stderr [in a C/Unix-like envornment]) or it may instead be presented through an on-screen interface, such as the “dashboard” interface shown in FIG. 9 (q.v.).

Although the preferred embodiment described in FIG. 6 performs validation in conjunction with a tool for generating a GUI from an XML-specification, the present invention is not limited to validating GUIs so generated. One skilled in the art will recognize that the present invention may be utilized to validate GUIs that have been manually coded or that have been generated by any of a potentially limitless number of GUI-generation tools. Further, an embodiment of the present invention need not also provide the ability to generate a GUI.

FIGS. 7-8 are diagrams illustrating portions of an XML validation document in which validation rules for GUI components are specified declaratively in accordance with a preferred embodiment of the present invention. The purpose of FIGS. 7-8 is to illustrate not only a preferred format for declaratively specifying validation rules but also the range of various types of rules and rule attributes that may be utilized in a preferred embodiment of the present invention. The validation document shown in FIGS. 7-8 is provided for example only, and is not intended to be a full specification of a set of validation rules.

It should also be pointed out that throughout this description of FIGS. 7-8, the term “element” is generally used to refer to a pair of opening and closing tags (as in element 704 in FIG. 7). Those skilled in the art will recognize that (conceptually, anyway) every opening tag in an XML document has a corresponding closing tag. This document follows a convention of enclosing the name of an element (i.e., a pair of opening and closing tags and the contents in-between) with angle brackets (<>). The “contents” of a tag are the text that appears between the opening and closing tags (e.g., reference symbol 728 in FIG. 7 corresponds to the contents of tag 726). Those skilled in the art will recognize that there is a shorthand notation in XML for an element that has no content. The shorthand notation “<tag/>” is equivalent to “<tag></tag>.” In FIGS. 7-8, where an element has contents, the element is generally identified (where possible) with a brace enclosing the entire element and its subelements (e.g., element 704 in FIG. 7, element 814 in FIG. 8, etc.). In some instances, where it is not practical to enclose the entire element in a brace, only the opening tag is annotated with a reference symbol and leader line (e.g., element 700, which spans across FIGS. 7-8).

Turning now to the content of FIG. 7, the validation document has a top-level element 700 with the name <rib:validate>. It should be noted at this point that the validation document makes use of the XML namespace “rib” to denote tags and attributes that are intrinsic to validation document format (hence, the element and attribute names are prefixed with “rib:”). Some elements have names that are not within the “rib” namespace; the significance of these names is described in more detail below.

Within top-level element 700 is <rib:scripts> element 702, the contents of which represents program code that will be incorporated verbatim into the validation code generated from the validation document. In this example, the contents of <rib:scripts> element 702 is written in Jython. <rib:scripts> element 702 allows include/import statements for including other source files or libraries, global variable/type declarations, and function/method definitions to be directly included into the validation code. In this example, the “AccessibleRelation” class from the “javax.accessibility” library in imported, an empty list called “VK_CODES” is created, and a Jython function called “isLetterVirtualKey” is defined. These global definitions can be used to enable certain functions, variables, or constants to be accessed from within validation rules.

The next second-level element is <rib:aliases> element 704, which allows for the definition of “aliases” for certain names, for convenience purposes. For example, <rib:alias> element 706, which is contained within <rib:aliases> element 704, defines one such alias in which the name “accName” (“rib:name” attribute 708) is defined as an alias for the longer, more cumbersome value of “accessibleName” (“rib:value” attribute 710). As will be seen, these aliases may be used in element names as well as attribute values, for convenience.

The core of the validation document is contained within <rib:components> element 712. <rib:components> element 712 encloses elements that refer to component types and their properties. These component type and property elements are used to specify the validation rules for different types of GUI components. The first of these in FIG. 7 is “Frame” element 714. Note that “Frame” element 714 is not within the “rib” XML namespace. That is because the name “Frame” is not a validation document-intrinsic construct, but is, in fact, the name of a type of GUI component (specifically, the class “JFrame,” which is defined in the JAVA standard library “javax.swing”). Element names that are not within the “rib” XML namespace correspond to component-types and properties, whose names are defined in the underlying programming language (in this case via pre-defined aliases included in validation tool 611).

<Frame> element 714 encloses <windowFocusListeners> element 716, which represents a property of “Frame” objects. Nesting <windowFocusListeners> element 716 into <Frame> element 714 creates a validation rule in which the “windowFocusListeners” property of every “Frame” object in the GUI must exist (i.e, it must be non-null). Properties in JAVA can generally be examined by calling a “getter” method, which, under the JavaBeans naming convention, has a name that is derived from the property name by capitalizing the first letter of the property name and prepending the word “get” to the name. Hence, the “getter” method for “windowFocusListeners” would be “getWindowFocusListeners.” Other properties may be examined by simply invoking the name of the property itself, as will be seen with respect to <length> element 718 below.

Property tags may be nested within other property tags. <length> element 718 is nested within <windowFocusListeners> element 716. Since the “windowFocusListeners” property of a “Frame” object is an array, <length> element 718 represents the length of that array. Hence <length> element 718 represents a property of the “windowsFocusListeners” property. Nested property tags such as <length> element 718 may be used to validate properties' properties against particular constraints. These constraints are represented as attributes of the property tag. In the case of <length> element 718, for instance, the length of an array is a numerical value. “rib:min” attribute 720 of <length> element 718 specifies that the minimum acceptable value for the length of the “windowsFocusListeners” array is 1 (i.e., there must be at least one windowsFocusListener assigned to a “Frame” object). Additional attributes of <length> element 718 specify the action to be taken in the event that this constraint is violated. “rib:severity” attribute 722 assigns a severity level (e.g., WARNING, ERROR, INFO, etc.) to the violation, which will be reported to the user/developer. “rib:message” attribute 724 defines a specific descriptive or explanatory message to be displayed in the event a violation occurs. When a “rib:message” attribute is not defined for a particular rule, a default message (e.g, “ERROR!” or “WARNING . . . ”) may be generated instead.

The validation constraints for component properties need not be limited to those that can be specified in simple element attributes. Instead, program code (more specifically, a conditional expression) may be executed for the purpose of determining whether a given property complies with a rule. Program code intended for this purpose is inserted as the contents of the property tag to which is pertains. For example, contents 728 of <focusTraversalPolicy> element 726 is a conditional expression in Jython that, when evaluated to obtain a “true” result, represents that the property in question (the “focusTraversalPolicy” property of a “Frame” object) complies with the validation rule. Special variable names “propertyvalue” and “thisComponent” are provided for this purpose (and represent the value of the property in question and the particular component in question, respectively).

Turning now to FIG. 8, additional validation document features are illustrated. <CheckBox> element 802 contains <accName> property element 804 (note that “accName” is an alias for “accessibleName,” which is the actual name of the property in the JAVA and Jython languages). While <accName> element 804 contains a “rib:severity” attribute, it does not contain any explicitly stated constraints. Nonetheless, <accName> element 804 defines a validation rule. Each property tag (whether having explicit constraints or not), by default, implies a rule that that property must exist (i.e, it must be non-null). Thus, <accName> element 804 defines a rule that the “accessibleName” property of a “CheckBox” object must exist. If it is desired to disable this explicit existence check for a given property, the “rib:ignoreifnull” property of the corresponding property tag can be set to “true.”

<length> element 808, which is nested within <accDesc> element 806, illustrates another type of numerical constraint. “rib:range” attribute 810 of <length> element 808 denotes that the <length” property of the “accessibleDescription” property (which is a String) of a “CheckBox” object must fall within the range of 8-25 characters.

<accRelSet> element 816 is nested within <RadioButton> element 814. <get> element 818 is, in turn, nested within <accRelSet> element 816. <get> element 818 represents a property that is accessed through a method in the “accessibleRelationSet” class called “get.” “rib:param” attribute 819 of <get> element 818 means that this “get” method should be called with a particular parameter in order to obtain the property to be validated. In this case, “rib:param” attribute 819 specifies that the parameter to be passed to the “get” method is defined by the alias “MEMBER_OF” (defined in FIG. 7). The fact that “MEMBER_OF” is an alias is denoted by the percent sign preceding “MEMBER_OF” in “rib:param” attribute 819. The property obtained by calling the “get” method with this parameter is a JAVA Set data structure. The contents of this Set data structure may be accessed using the “target” method of the Set. <target> element 820 defines a constraint on the contents of the Set. “rib:instanceof” attribute 821 (which is set to “ButtonGroup”) and “rib:index” attribute 823 (which is set to “ALL”) of “target> element 820 together impose the constraint that all members of the Set specified by <get> element 818 must be instances of the class <ButtonGroup.”

<rib:scripttest> element 822, which is nested within <RadioButton> element 814, encloses contents 824, which comprises a conditional expression in program code (Jython in this example). Contents 824 is a test that pertains to the “RadioButton” component as a whole. If contents 824 is executed and evaluates to “true,” the component passes the test. If contents 824 is executed and evaluates to false, then the component fails the test and the failure is recorded.

<Label> element 824 illustrates another useful feature for defining validation rules, Boolean operator tags. <rib:or> element 826 defines a disjunction (logical “or”) of validation rules. That is, <rib:or> element 826 specifies that compliance with either of the rules nested within <rib:or> element 826 will suffice. Thus, in this example, if the validation test associated with <labelFor> element 828 fails, but the validation test associated with <accRelSet> element 830 succeeds, no error or warning message will result. Similarly, a preferred embodiment of the present invention provides a <rib:and> facility as well.

Additional tests and other validation constraints may be employed in an actual embodiment of the present invention. For example, a preferred embodiment defines <rib:max> (for maximum value), <rib:eq> (for equality test), <rib:neq> (for inequality test), and <rib:regexp> (for regular expression recognition) constraints that may be employed to validate against a wide variety of different constraints. Other such constraint types and relational and logical operators that may be utilized within an embodiment of the present invention will be apparent to those skilled in the art.

In a preferred embodiment of the present invention, a validation document, such as that described in FIGS. 7-8, is used to generate validation code for inclusion (via aspect-oriented programming) in a GUI-based application. When the application is executed, the validation code executes, traverses the GUI hierarchy, and tests each GUI component against the constraints and tests defined in the validation document. The validation code also reports the results of the validation (e.g, error and warning messages generated by verifying non-compliant components). These results may take the form of plain text (such as in a logfile or messages displayed on the user's terminal) or they may be presented in a more “beautified” form through the use of a specialized interface. One such interface is described in FIG. 9.

FIG. 9 is a diagram illustrating a “dashboard” interface 900 for reporting the results of GUI validation to a user in accordance with a preferred embodiment of the present invention. Dashboard 900 lists IDs 902 of GUI components that failed validation and corresponding explanatory messages 904, which indicate why those particular components failed validation. Messages 904 include those messages specified using “rib:message” attributes (as in FIGS. 7 and 8) as well as default messages generated when no specific message has been defined for a given rule.

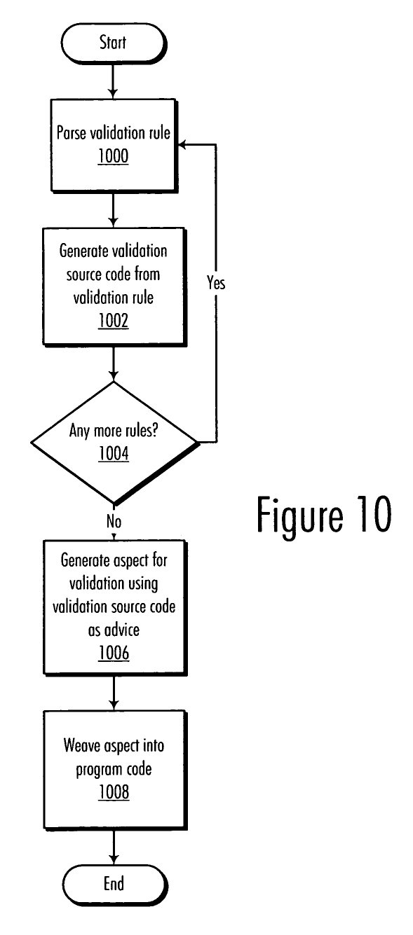

FIG. 10 is a flowchart representation of a process of generating validation code from a declarative representation of validation rules and incorporating that validation code into a program to be validated in accordance with a preferred embodiment of the present invention. First, a validation rule from the validation document is parsed to determine the desired condition to test (block 1000). Validation source for testing the condition with respect to a component is generated from the parsed rule (block 1002). If there are additional rules in the validation document (block 1004:Yes), the process repeats with the next rule (block 1000).

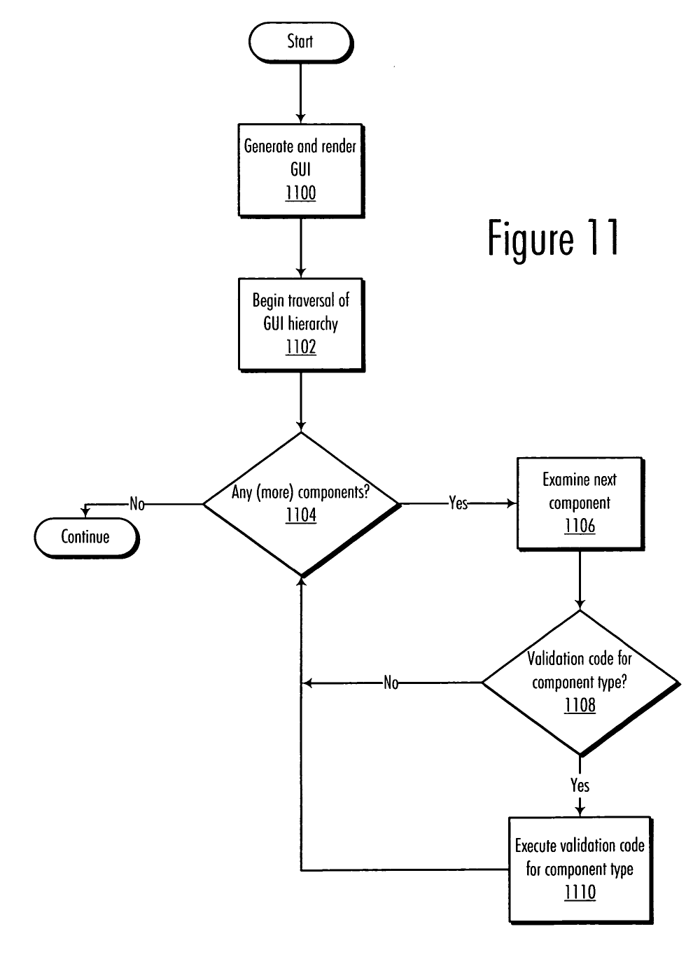

Once there are no more rules to be parsed from the validation document (block 1004:No), the generated validation code is incorporated into an aspect as advice code for the aspect (block 1006). The pointcut for the aspect will specify a point in the program where the GUI is generated or rendered so that the GUI components to be validated will be in a reasonably complete state. Finally, this aspect is woven into the program code so that validation of the program's GUI components (illustrated in FIG. 11) will take place at the point(s) in which the GUI is generated or rendered (block 1008).

FIG. 11 is a flowchart representation of a process of validating a graphical user interface using aspect-oriented validation code in accordance with a preferred embodiment of the present invention. First, the GUI is generated and rendered (block 1100). This results in execution of advice code represented here by blocks 1102-1110. The GUI component hierarchy is traversed component-by-component (block 1102). While there are components in the hierarchy to traverse (block 1104:Yes), the next component in the traversal of the hierarchy is examined (block 1106). If there was validation code generated for that component's component-type (block 1108:Yes), that code is executed to determine if the component complies with the validation rules specified for that component type and, if not, to report that fact to the user/developer (block 1110). Once all components in the hierarchy have been examined (block 1104:No), regular execution of the application resumes (i.e., validation ends).

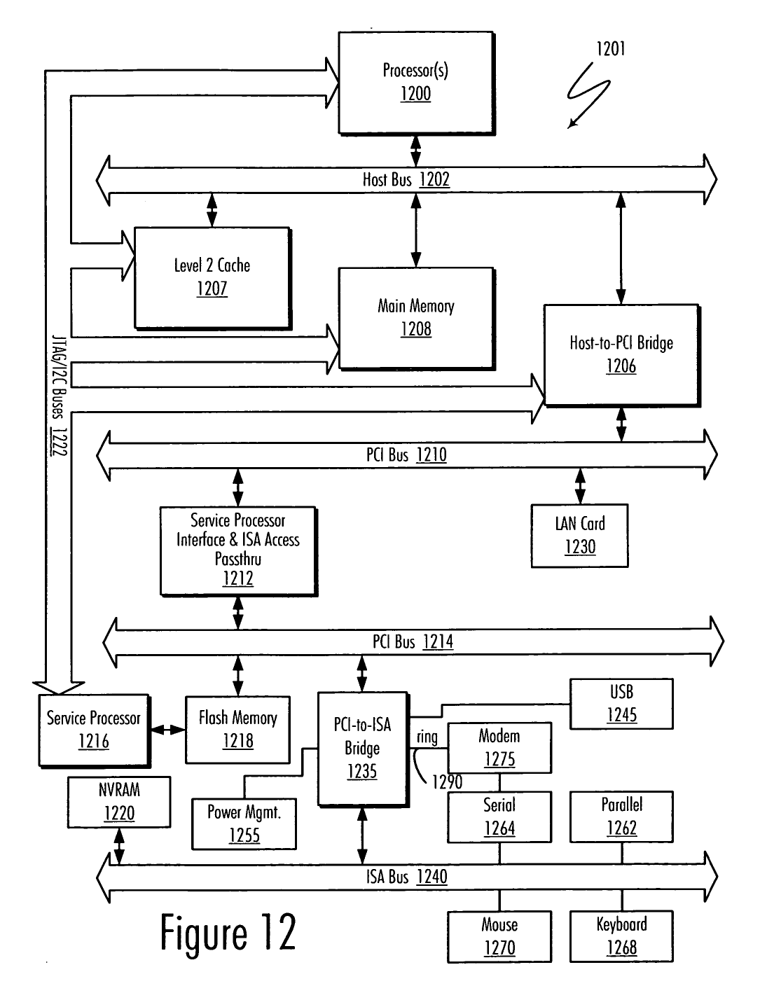

FIG. 12 illustrates information handling system 1201, which is a simplified example of a computer system capable of performing the computing operations of the host computer described herein with respect to a preferred embodiment of the present invention. Computer system 1201 includes processor 1200 which is coupled to host bus 1202. A level two (L2) cache memory 1204 is also coupled to host bus 1202. Host-to-PCI bridge 1206 is coupled to main memory 1208, includes cache memory and main memory control functions, and provides bus control to handle transfers among PCI bus 1210, processor 1200, L2 cache 1204, main memory 1208, and host bus 1202. Main memory 1208 is coupled to Host-to-PCI bridge 1206 as well as host bus 1202. Devices used solely by host processor(s) 1200, such as LAN card 1230, are coupled to PCI bus 1210. Service Processor Interface and ISA Access Pass-through 1212 provides an interface between PCI bus 1210 and PCI bus 1214. In this manner, PCI bus 1214 is insulated from PCI bus 1210. Devices, such as flash memory 1218, are coupled to PCI bus 1214. In one implementation, flash memory 1218 includes BIOS code that incorporates the necessary processor executable code for a variety of low-level system functions and system boot functions.

PCI bus 1214 provides an interface for a variety of devices that are shared by host processor(s) 1200 and Service Processor 1216 including, for example, flash memory 1218. PCI-to-ISA bridge 1235 provides bus control to handle transfers between PCI bus 1214 and ISA bus 1240, universal serial bus (USB) functionality 1245, power management functionality 1255, and can include other functional elements not shown, such as a real-time clock (RTC), DMA control, interrupt support, and system management bus support. Nonvolatile RAM 1220 is attached to ISA Bus 1240. Service Processor 1216 includes JTAG and I2C buses 1222 for communication with processor(s) 1200 during initialization steps. JTAG/I2C buses 1222 are also coupled to L2 cache 1204, Host-to-PCI bridge 1206, and main memory 1208 providing a communications path between the processor, the Service Processor, the L2 cache, the Host-to-PCI bridge, and the main memory. Service Processor 1216 also has access to system power resources for powering down information handling device 1201.

Peripheral devices and input/output (I/O) devices can be attached to various interfaces (e.g., parallel interface 1262, serial interface 1264, keyboard interface 1268, and mouse interface 1270 coupled to ISA bus 1240. Alternatively, many I/O devices can be accommodated by a super I/O controller (not shown) attached to ISA bus 1240.

In order to attach computer system 1201 to another computer system to copy files over a network, LAN card 1230 is coupled to PCI bus 1210. Similarly, to connect computer system 1201 to an ISP to connect to the Internet using a telephone line connection, modem 1275 is connected to serial port 1264 and PCI-to-ISA Bridge 1235.

While the computer system described in FIG. 12 is capable of supporting the methods described herein, this computer system is simply one example of a computer system. Those skilled in the art will appreciate that many other computer system designs are capable of performing the processes described herein.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an;” the same holds true for the use in the claims of definite articles.

What is claimed is:

1. A computer-executed method comprising:
generating validation code from a declarative representation of user interface validation rules, wherein the validation code includes instructions for verifying that user interface components comply with the user interface validation rules; and
instrumenting an application with an aspect, wherein the aspect is associated with advice code and the advice code includes the validation code.

2. The method of claim 1, wherein the aspect is associated with a pointcut corresponding to generation of the user interface.

3. The method of claim 1, wherein the declarative representation includes tags in a markup language.

4. The method of claim 3, wherein the tags include at least one component tag representing a user interface component type.

5. The method of claim 3, wherein the tags include at least one property tag representing a property of a user interface component.

6. The method of claim 5, wherein the at least one property tag includes an attribute corresponding to a constraint relating to a user interface property.

7. The method of claim 1, wherein the declarative representation includes test code and generating the validation code includes incorporating the test code into the validation code.

8. The method of claim 1, further comprising:
executing the instrumented application, wherein executing the instrumented application includes executing the validation code to obtain validation results.

9. The method of claim 8, further comprising:
generating a validation report from the validation results.

10. A computer program product in a computer readable medium comprising functional descriptive material that, when executed by a computer, directs the computer to perform actions that include:
generating validation code from a declarative representation of user interface validation rules, wherein the validation code includes instructions for verifying that user interface components comply with the user interface validation rules; and
instrumenting an application with an aspect, wherein the aspect is associated with advice code and the advice code includes the validation code.

11. The computer program product of claim 10, wherein the aspect is associated with a pointcut corresponding to generation of the user interface.

12. The computer program product of claim 10, wherein the declarative representation includes tags in a markup language.

13. The computer program product of claim 12, wherein the tags include at least one component tag representing a user interface component type.

14. The computer program product of claim 12, wherein the tags include at least one property tag representing a property of a user interface component.

15. The computer program product of claim 14, wherein the at least one property tag includes an attribute corresponding to a constraint relating to a user interface property.

16. The computer program product of claim 10, wherein the declarative representation includes test code and generating the validation code includes incorporating the test code into the validation code.

17. The computer program product of claim 10, comprising additional functional descriptive material that, when executed by a computer, directs the computer to perform actions that include:
executing the instrumented application, wherein executing the instrumented application includes executing the validation code to obtain validation results.

18. The computer program product of claim 17, comprising additional functional descriptive material that, when executed by a computer, directs the computer to perform actions that include:
generating a validation report from the validation results.

19. A data processing system comprising:
at least one processor;
at least one data store associated with the at least one processor; and
a set of instructions in the at least one data store, wherein the at least one processor executes the set instructions to perform actions that include:
generating validation code from a declarative representation of user interface validation rules, wherein the validation code includes instructions for verifying that user interface components comply with the user interface validation rules; and
instrumenting an application with an aspect, wherein the aspect is associated with advice code and the advice code includes the validation code.

20. The data processing system of claim 19, wherein the declarative representation includes test code and generating the validation code includes incorporating the test code into the validation code.
